(19) United States
(12) Patent Application Publication
(10) Pub. No.: US 2021/0318988 A1
(43) Pub. Date: Oct. 14, 2021

(54) SHARED STORAGE FILE SYSTEM MECHANISM

(71) Applicant: Hewlett Packard Enterprise Development LP, Houston, TX (US)

(72) Inventors: Erik Jacobson, Eagan, MN (US); Paul Schliep, Eagan, MN (US); Arjav Shah, Berkeley Heights, NJ (US)

(21) Appl. No.: 16/843,131

(22) Filed: Apr. 8, 2020

(51) Int. Cl. G06F 16/176; G06F 16/178; G06F 16/182; G06F 16/18; G06F 8/61

(52) U.S. Cl. CPC G06F 16/176; G06F 16/178; G06F 8/63; G06F 16/1873; G06F 16/182

(57) ABSTRACT

A high-performance computing (HPC) system is described. The system includes at least one administrative leader node including a distributed file system server to host a plurality of filesystem images to facilitate a shared filed system, one or more storage devices configured as shared storage having a writable area to host filesystem images for the shared filed system and a plurality of compute nodes, wherein each compute node to mount a compute-node specific directory received from the server in the writable area in the shared storage and mount a filesystem within a filesystem image as a read-write area at the shared storage.

### BACKGROUND

High-performance computing (HPC) provides the ability to process data and perform complex calculations at high speeds. An HPC cluster is a collection of many separate servers (computers), called nodes, which are connected via a fast interconnect. An HPC cluster includes different types of nodes that perform different tasks, including a head node, data transfer node, compute nodes and a switch fabric to connect all of the nodes. Exascale computing refers to an HPC system that is capable of at least a quintillion (e.g., a billion billion) calculations per second (or one exaFLOPS).

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates one embodiment of a system comprising an HPC cluster.

FIG. 2 is a block diagram illustrating another embodiment of an HPC cluster.

FIG. 3 is a block diagram illustrating one embodiment of administrative node.

FIG. 4 illustrates one embodiment of a compute node.

FIG. 5 is a flow diagram illustrating one embodiment of an overmount process.

FIG. 6 is a flow diagram illustrating one embodiment of an overlay process.

### DETAILED DESCRIPTION

Exascale clusters include thousands of nodes that need to be configured prior to operation. In addition, HPC clusters are often tuned at a low level for things like memory bandwidth, networking, and the like. A problem with scalability of HPCs is supplying a persistent root filesystem for thousands of compute nodes that do not have storage drives. A root file system is a file system included on the same disk partition on which a root directory is located. Thus, the root file system is the filesystem on top of which all other file systems are mounted as a system boots up, and is implemented to control how data is stored and retrieved. In a typical diskless HPC compute node, the root filesystem is served from one or more external servers and provided by ways of a network filesystem.

Often, shared storage is implemented to store file system images for each diskless compute node in an HPC cluster. The shared storage may aggregate storage for the compute nodes using containers or virtual machines, or may reside directly on the native servers. However, such shared storage solutions are inefficient when having to write small files associated with each compute node. For example, in a typical HPC boot scenario, a compute node mounts a network filesystem (NFS) (e.g., a read-only mount point) from an administrative leader node. Subsequently, a writable NFS mount point is made using a directory specific to the compute node during the boot process. The writable NFS area is bind-mounted to locations that need to be writable for the compute node. At this point, an operation may copy the contents of some locations that need to be writable (e.g., locations such as /etc, /root, /var/, and similar paths that normally need to be writable). Whenever this process is attempted with an administrative leader node that is using shared storage for the filesystem, the step that copies the writable areas is very slow since it may have to write thousands of small files. In addition, running jobs that write a lot of small files are inefficient, including the boot process itself.

As defined herein, NFS is a distributed file system protocol that allows sharing of remote directories over a network. Thus, directories can be mounted on a compute node and operate with the remote files as if they were local files. Additionally, mounting may be defined as a process by which an operating system makes files and directories available for compute nodes to access via the file system. A bind mount is an alternate view of a directory tree in which an existing directory tree is replicated under a different point. However, the directories and files in the bind mount are the same as the original.

According to one embodiment, a mechanism is provided to facilitate node configuration in a high-performance computing (HPC) system. The mechanism incudes a boot process in which shared storage includes a writeable area to host individual filesystem images for each of a plurality of compute nodes. In a further embodiment, a compute node mounts a compute-node specific directory received from an NFS server in the writable area prior to mounting the filesystem within a filesystem image as a read-write NFS area at the shared storage. As a result, it appears to the NFS server and the shared file system that each compute node is manipulating a single file for writes, rather than thousands of small files. In a further embodiment, the NFS server may be a service offered by the shared storage hardware or software. Although described herein with reference to a NFS network file system, other embodiments may implement different network file systems (e.g., Gluster, CephFS, etc.).

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Throughout this document, terms like “logic”, “component”, “module”, “engine”, “model”, and the like, may be referenced interchangeably and include, by way of example, software, hardware, and/or any combination of software and hardware, such as firmware. Further, any use of a particular brand, word, term, phrase, name, and/or acronym, should not be read to limit embodiments to software or devices that carry that label in products or in literature external to this document.

It is contemplated that any number and type of components may be added to and/or removed to facilitate various embodiments including adding, removing, and/or enhancing certain features. For brevity, clarity, and ease of understanding, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

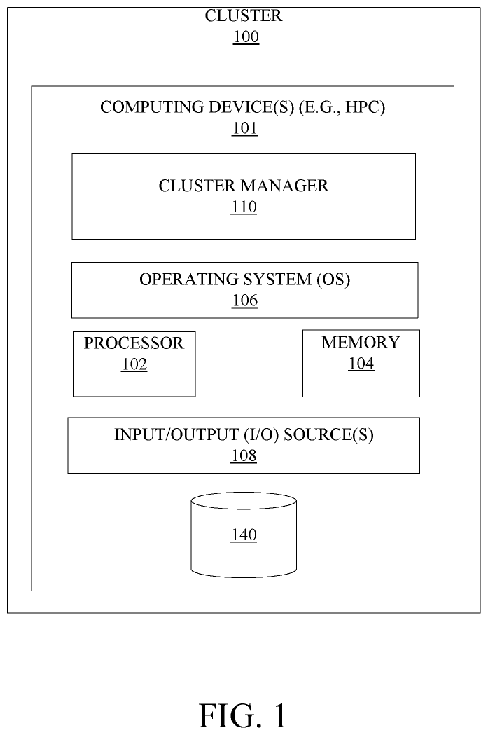

FIG. 1 illustrates one embodiment of a cluster 100. As shown in FIG. 1, data cluster 100 includes one or more computing devices 101 that operate as high-performance computing (HPC) cluster components. In embodiments, a computing device 101 may include (without limitation) server computers (e.g., cloud server computers, etc.), desktop computers, cluster-based computers, set-top boxes (e.g., Internet-based cable television set-top boxes, etc.), etc. Computing device 101 includes an operating system (“OS”) 106 serving as an interface between one or more hardware/physical resources of computing device 101 and one or more client devices, not shown. Computing device 101 further includes processor(s) 102, memory 104, input/output (“I/O”) sources 108, such as touchscreens, touch panels, touch pads, virtual or regular keyboards, virtual or regular mice, etc.

In one embodiment, computing device 101 includes a server computer that may be further in communication with one or more databases or storage repositories, such as database 140, which may be located locally or remotely over one or more networks (e.g., cloud network, Internet, proximity network, intranet, Internet of Things (“IoT”), Cloud of Things (“CoT”), etc.). Computing device 101 may be in communication with any number and type of other computing devices via one or more networks.

According to one embodiment, computing device 101 implements a cluster manager 110 to manage cluster 100. In one embodiment, cluster manager 110 provides for provisioning, management (e.g., image management, software updates, power management and cluster health management, etc.) and monitoring of cluster nodes. In a further embodiment, cluster manager 110 provides for configuration of cluster compute nodes.

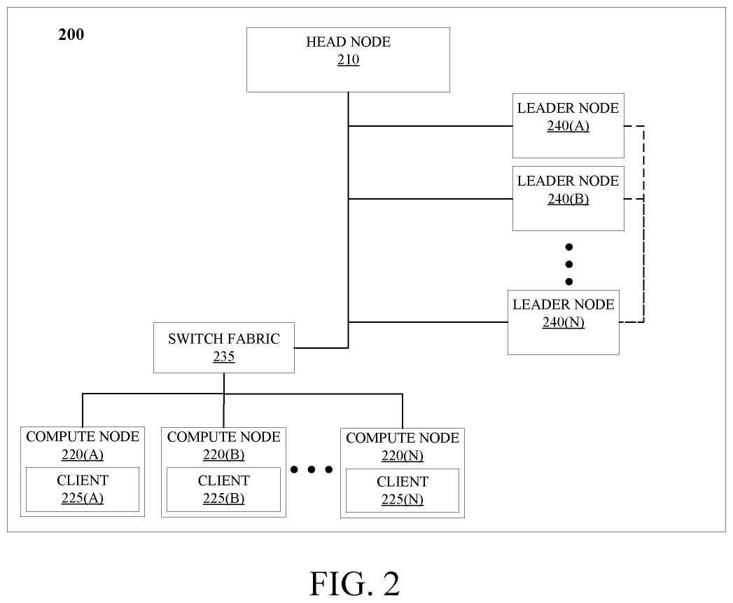

FIG. 2 is a block diagram illustrating another embodiment of an HPC cluster 200. As shown in FIG. 2, cluster 200 includes a head node 210 coupled to compute nodes 220 (e.g., compute nodes 220(A)-220(N)) via a switch fabric 235, and leader nodes 240 (e.g., leader nodes 240(A)-240(N)). In one embodiment, head node 210 provides management and job scheduling services to the cluster of compute nodes 220. In such an embodiment, head node 210 operates as a launching point for workloads (or jobs) for processing at compute nodes 220.

Compute nodes 220 perform computational operations to execute workloads. In one embodiment, compute nodes 220 operate in parallel to process the workloads. In one embodiment, compute nodes 220 are diskless compute nodes. Switch fabric 235 comprises a network of switches that interconnect head node 210, compute nodes 220 and leader nodes 240.

According to one embodiment leader nodes 240 operate as installation servers for compute nodes 220. In such an embodiment, a leader node 240 configures each compute node 220 to receive a Preboot eXecution Environment (PXE). A PXE describes a standardized client-server environment that boots a software assembly, retrieved from a network, on PXE-enabled clients. However in other embodiments, compute nodes may initiate the boot process upon retrieving a file included in a dynamic host configuration protocol (DHCP) via hypertext transfer protocol (HTTP). In a further embodiment, a compute node 220 connects to a leader node 240 to perform a boot operation. In still a further embodiment, head node 210 facilitates the deployment of image files (e.g., operating system and filesystem images).

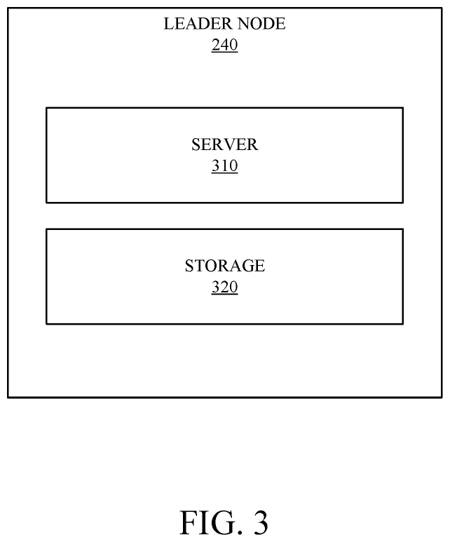

FIG. 3 is a block diagram illustrating one embodiment of a leader node 240. As shown in FIG. 3, leader node 240 includes server 310. In one embodiment, server 310 is implemented to export storage of mounts for compute nodes 210 to shared storage at storage devices 320 within each leader node 320. Storage devices 320 comprise a plurality of devices that provide data storage for HPC cluster 200. In embodiments, storage devices 320 may comprise Serial Attached SCSI (SAS), Serial Advanced Technology Attachment (SATA) hard disk drives. However, in other embodiments, storage devices 320 may comprise solid state drives (SSDs).

According to one embodiment, storage devices 320 may be configured according to a cluster file system that integrates the devices 320 to operate as a single file system that aggregates the storage capabilities of each of storage devices 320(A)-320(N). For example, storage devices 320 may be configured as a Redundant Array of Independent Disks (RAID) to combine storage devices 320(A)-320(N) into one or more logical units for the purposes of data redundancy and/or performance improvement.

In a further embodiment, a centralized redundant storage device may be connected to a Storage Area Network (SAN) and in turn be connected to the leader nodes with a shared filesystem. An exemplary storage device is an HPE MSA 2050 using redundant controllers and redundant SAS, fibre channel, or private network connections to the leader nodes. In yet a further embodiment, cluster manager 110 configures cluster 200 resources (e.g., compute nodes 210 and storage devices 320) as one or more Point of Developments (PODs) (or instance machines), where an instance machine (or instance) comprises a cluster of infrastructure (e.g., compute, storage, software, networking equipment, etc.) that operate collectively. In still a further embodiment, instances may be implemented via containers or virtual machines.

In one embodiment, server 310 is implemented on each of leader nodes 240 and is accessed by compute nodes 210 via an internet protocol (IP) address. Thus, if a leader node 240 at which a server 310 is operating becomes inoperative (e.g., via an outage), a server 310 at another leader node 240 is implemented. In a further embodiment, server 310 facilitates mounting of a network filesystem at compute nodes 210. In such an embodiment, each compute node 210 includes a client application 225 (FIG. 2).

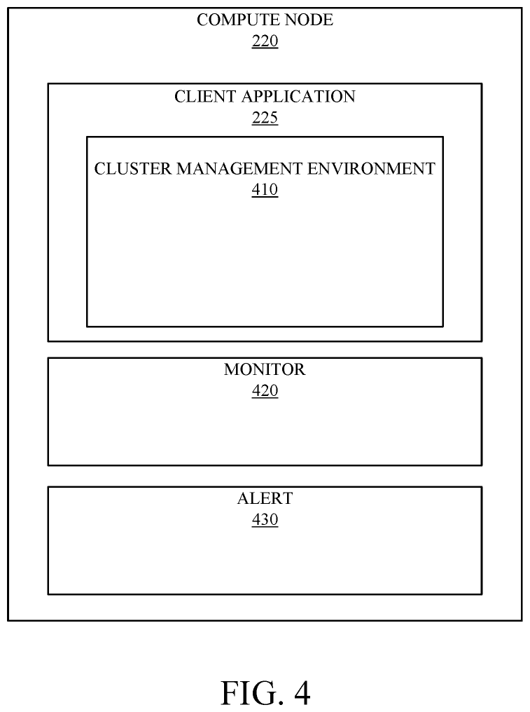

FIG. 4 illustrates one embodiment of a compute node 220. As shown in FIG. 4, compute node 220 includes client application 225 having a cluster management environment 410. According to one embodiment, cluster management environment 410 performs network booting at a compute node. In a further embodiment, cluster management environment 410 is implemented to mount read-only and read-write NFS filesystem images, as well as perform node configuration and startup. However in other embodiments, cluster management environment 410 may be implemented using initial ramdisk (initrd).

In one embodiment, cluster management environment 410 is implemented to perform an overmount process to provide a read only NFS root filesystem with read-write NFS image overmounts. As defined herein, an overmount process comprises using a mount point served from a different location (e.g., a different directory) and mounting that content on top of directories that already exist.

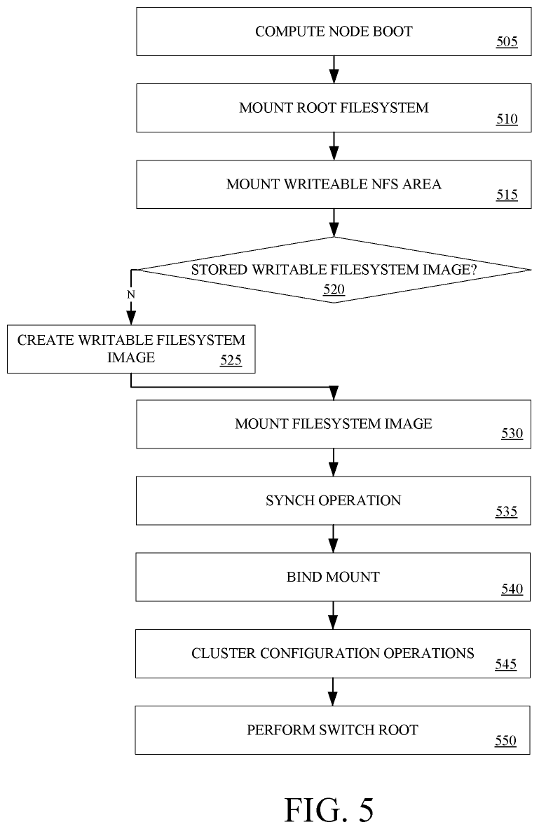

FIG. 5 is a flow diagram illustrating one embodiment of an overmount process performed at a compute node 220. At processing block 505, the compute node boots into the cluster management environment. At processing block 510, the cluster management environment mounts the root filesystem as read-only to a location (e.g., /ro_nfs) in shared storage (e.g., storage devices 320). In one embodiment, the read-only root filesystem is shared by one or more other compute nodes 210. In a further embodiment, the read-only root filesystem is exported from the NFS server. However, in other embodiments, the read-only base root filesystem may comprise a filesystem image of a root filesystem received from an external source.

At processing block 515, the cluster management environment mounts a compute node specific writeable NFS area to shared storage area (e.g., /rw_nfs). At decision block 520, the cluster management environment determines whether there is a filesystem image for writable content currently stored in the writable NFS location. If not, a filesystem image for writable content is created and mounted to the writable NFS location, processing block 525. In one embodiment, the filesystem image for writable content is created by creating a sparse image on the read-write NFS mount (e.g., using the Linux “dd” command with the “seek” option or the Linux ‘truncate’ command). Subsequently, a filesystem is created (e.g., an XFS filestream).

Upon a determination at decision block 520 that the filesystem image for writable content is stored in the writable NFS location, or generation of the filesystem image for writable content at processing block 525, the cluster management environment mounts the filesystem image to an image location (e.g., /rw_image) at processing block 530. At this point, the path including the image is /rw_nfs, while the actual image is located at /rw_image. Thus, at processing block 535, a synchronization (or synch) operation is performed. In one embodiment, the synch operation comprises synching a list of paths from the read-only NFS path to the read-write image (e.g., on top of the read-write NFS path). This seeds the content in those directories. In a further embodiment, the paths comprise modifiable paths (e.g., including “/etc”, “/root”, “/var”). Thus, the synch operation results in rw_nfs/etc, rw_nfs/root, rw_nfs/var, etc.

At processing block 540, a bind mount is performed to mount the components into a final location. As a result, a complete root environment has been established under ro_nfs (e.g., rw_nfs/var is mounted over /ro_nfs/var, /rw_nfs/etc is mounted over /ro_nfs_/etc, etc.) At processing block 545, the cluster management environment may perform cluster configuration operations on top of /a (e.g., setting the system host name, configuring network settings, and other configurations). At processing block 550, a switch root (or switch_root) operation is performed to change ro_nfs into a true root filesystem for startup (e.g., init or systemd). Once booted (e.g., into Linux), “/” becomes what was previously /ro_nfs with the read-write areas over-mounted. Thus, post-boot, /etc is writable, /lib is read-only, /var is writable, etc. In one embodiment, a switch root is an operating concept in which an initial boot environment (e.g., initrd or miniroot) sets up the filesystem and once prepared, switches that filesystem to be the real root filesystem for the operating system as it boots up normally. In this embodiment, the boot environment uses an in-memory root to initially boot and mount what will become the future root, then switches to the root and switches control to operating system startup.

In an alternative embodiment, cluster management environment 410 may be implemented to perform an overlay process to provide a read only NFS root filesystem with read-write NFS image as an overlay. An overlay comprises a writable area (e.g., the filesystem on a top of a single file) that is combined with the read-only filesystem to form a copy-on-write union. The operating system kernel subsequently automatically overrides original read-only content with content that has been included in the overlay. Accordingly, the entire root filesystem may be configured to appear as a writable environment. As files change, the changed files are placed in the overlay. In contrast, an overmount only allows directories to change in the locations at which they are mounted.

In one embodiment, a union mounting filesystem (e.g., Linux OverlayFS) is implemented as a copy-on-write implementation. As defined herein, union mounting enables a combining of multiple directories into a single directory that appears to include the combined contents. As a result, union mounting takes a base filesystem (e.g., “lowerdir”) and combines it with a writable filesystem (e.g., “upperdir”) into a mount point. Once mounted, files are copied (e.g., if there is a change) into the writable space, which allows the compute node 220 to completely appear as a writable filesystem even though based on a read-only NFS mount point. This embodiment enables an installation of distribution packages (e.g., RPMs) and file changes, while maintaining writability (e.g., like a conventional hard drive-based root filesystem). The creation of the filesystem image for writable content is performed in a similar manner to the overmount process discussed above, with the exception of no synchronization being needed. The mounted filesystem (e.g., the XFS filesystem created on the sparse file) is mounted and passed as ‘upperdir’ above.

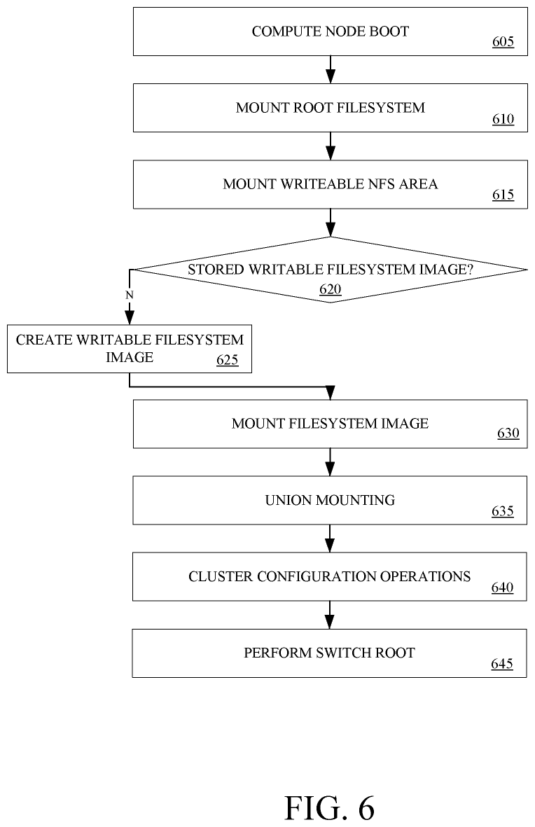

FIG. 6 is a flow diagram illustrating one embodiment of an overlay process. At processing block 605, the compute node boots into the cluster management environment. At processing block 610, the cluster management environment mounts the root filesystem as read-only to a location (e.g., /ro_nfs). At processing block 615, the cluster management environment mounts a compute node specific writeable NFS area from the NFS server to shared storage area (e.g., /rw_nfs). At decision block 620, the cluster management environment determines whether there is a filesystem image for writable content currently stored in the writable NFS location. If not, a filesystem image for writable content is created and mounted to the writable NFS location, processing block 625.

At processing block 630, the cluster management environment mounts the filesystem image to a location (e.g., /rw_image). At processing block 635, the cluster management environment performs a union mounting process (e.g., using OverlayFS) using /ro_nfs as the base (or “lowerdir”) and /rw_nfs as the “upperdir”. Subsequently, the cluster management environment mounts this union to a specific point, (e.g., “/a”). At processing block 640, the cluster management environment may perform cluster configuration operations on top of /a (e.g. configuring network interfaces). At processing block 645, a switch root operation is performed.

Referring back to FIG. 4, compute node 220 also includes a monitor 420 to monitor available space on the read-write filesystem image mount point. In such an embodiment, monitor 420 may issue a command (e.g., df in Linux) to show used and available space. Subsequently, monitor 420 may collect the used and available space data. In one embodiment, the used/available metrics may be aggregated at head node 210 into a time-series database (e.g., a round robin database (RRD)) and transformed into graphical views. Alert engine 430 transmits a signal to alert head node 210 upon monitor 420 detecting that administrator available space is becoming low. Thus, monitor 420 facilitates the notification of the shared storage area for a cluster of compute nodes 220 running out of disk space attributed to an errant writing of files to a writable path, such as in /etc.

In a further embodiment, disk space may be extended (e.g., via an administrator at head node 210) upon monitor 420 detecting that the currently allocated space is not sufficient. In this embodiment, writable image files may be extended by head node 210 since it can natively mount the leader node 240 shared storage. In a further embodiment, a leader node 240 that is not a part of the shared storage pool may be implemented. This process may be performed with the Linux “dd” or “truncate” command to append open space to the end of an image file. In yet a further embodiment, a notification is transmitted to compute nodes 220 for the next boot to instruct the compute nodes 220 (e.g., via cluster management environment 410) to expand the writable filesystem residing in the image to fill the additional space.

According to one embodiment, image files that make up the compute node 220 writable storage may be deleted. This may occur in scenarios in which significant changes are to be pushed to an image. For the overlay embodiment, the cluster management tools may automatically delete the persistent storage to ensure the overlay mount is consistent. Because the compute nodes 220 automatically create the image files on the writable NFS storage if they do not exist, the image files are deleted so that compute nodes 220 can create new image files when subsequently instructed.

The above-described mechanism maintains the benefits of shared storage, which includes high availability and resiliency. Additionally, the mechanism permits for the maintenance of a small number of operating system images, even if the compute node count is in the tens of thousands. Further, the mechanism may provide a solution to speed up a boot process when writable persistent storage is required for root filesystems on nodes without disks.

Embodiments may be implemented as any or a combination of one or more microchips or integrated circuits interconnected using a parent board, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A computing system comprising:
a plurality of leader nodes, each leader node including:
a distributed file system server to host a plurality of filesystem images to facilitate a shared filed system; and
one or more storage devices, wherein the one or more storage devices at the leader nodes are configured as shared storage having a writable area to host filesystem images for the shared filed system; and
a plurality of compute nodes, wherein each compute node to mount a compute-node specific directory received from a server in the writable area in the shared storage and mount a filesystem within a filesystem image as a read-write area at the shared storage.

2. The system of claim 1, wherein a compute node includes one or more processors to execute a cluster management environment prior to receiving a filesystem image.

3. The system of claim 2, wherein the cluster management environment mounts a read-only root filesystem to the shared storage.

4. The system of claim 3, wherein the cluster management environment mounts a compute node specific writable location at the shared storage.

5. The system of claim 4, wherein the cluster management environment determines whether a filesystem image for writable content is currently located at the writable location.

6. The system of claim 5, wherein the cluster management environment creates the filesystem image for writable content upon a determination that no filesystem image is currently located at the writable location.

7. The system of claim 6, wherein the cluster management environment mounts the filesystem image to an image location at the shared storage.

8. The system of claim 7, wherein the cluster management environment synchronizes a list of paths from the read-only root filesystem to the writable location.

9. The system of claim 7, wherein the cluster management environment performs a union mounting to bind the writable to the read-write area.

10. The system of claim 9, further comprising a head node coupled to the administrative leader node to facilitate configuration of the server.

11. A method to facilitate configuration of a shared file system among a plurality of compute nodes, comprising:
a first of the plurality of compute nodes receiving a compute-node specific directory from a distributed file system server;
the first compute node mounting the compute-node specific directory in a writable area in shared storage; and
the first compute node mounting a filesystem within a filesystem image as a read-write area at the shared storage.

12. The method of claim 11, further comprising:
the first compute node mounting a read-only root filesystem to the shared storage; and
the first compute node mounting a compute node specific writable location at the shared storage.

13. The method of claim 12, further comprising the first compute node determining whether a filesystem image for writable content is currently located at the writable location.

14. The method of claim 13, further comprising:
the first compute node creating the filesystem image for writable content upon a determination that no filesystem image is currently located at the writable location; and
the first compute node mounting the filesystem image to an image location at the shared storage.

15. The method of claim 14, the first compute node synchronizing a list of paths from the read-only root filesystem to the writable location.

16. The method of claim 14, the first compute node performs a union mounting to bind the writable to the read-write area.

17. A non-transitory machine-readable medium storing instructions which, when executed by a processor, cause the processor to:
receive a compute-node specific directory from a distributed file system server;
mount the compute-node specific directory in a writable area in shared storage; and
mount a filesystem within a filesystem image as a read-write area at the shared storage.

18. The non-transitory machine-readable medium of claim 17, storing instructions which, when executed by a processor, cause the processor to:
mount a read-only root filesystem to the shared storage; and
mount a compute node specific writable location at the shared storage.

19. The non-transitory machine-readable medium of claim 18, storing instructions which, when executed by a processor, cause the processor to gene determine whether a filesystem image for writable content is currently located at the writable location.

20. The non-transitory machine-readable medium of claim 19, storing instructions which, when executed by a processor, cause the processor to:
create the filesystem image for writable content upon a determination that no filesystem image is currently located at the writable location; and
mount the filesystem image to an image location at the shared storage.
